(19) United States
(12) Patent Application Publication
(10) Pub. No.: US 2020/0233061 A1
(43) Pub. Date: Jul. 23, 2020

(54) METHOD AND SYSTEM FOR CREATING AN INVERSE SENSOR MODEL AND METHOD FOR DETECTING OBSTACLES

(71) Applicant: Robert Bosch GmbH, Stuttgart (DE)

(72) Inventors: Stefan Lang, Benningen (DE); Thomas Gussner, Ludwigsburg (DE)

(21) Appl. No.: 16/651,335

(22) PCT Filed: Oct. 4, 2018
(86) PCT No.: PCT/EP2018/076986

§ 371 Date: Mar. 26, 2020

(30) Foreign Application Priority Data
Oct. 10, 2017 (DE) 10 2017 217 972.4

(51) Int. Cl. G01S 7/40; G01S 13/931; B60W 40/02; G08G 1/16

(52) U.S. Cl. CPC G01S 7/40; G08G 1/165; B60W 40/02; G01S 13/931

(57) ABSTRACT

A method for creating an inverse sensor model for a radar sensor system. The method comprises: placing obstacles having predefined dimensions and spatial positions in a surrounding field of the radar sensor system; the radar sensor system generating radar measurement data; and generating the inverse sensor model using the generated radar measurement data and the predefined dimensions and spatial positions of the obstacles, the inverse sensor model assigning an occupancy probability as a function of predefined radar measurement data to a cell of an occupancy grid.

### FIELD

The present invention relates to a method and a system for creating an inverse sensor model for a radar sensor system. The present invention also relates to a method for detecting obstacles in a driving environment of a vehicle using a radar sensor system.

### BACKGROUND INFORMATION

Driver assistance systems, which render possible semi-autonomous or autonomous driving, must be able to access accurate information about the driving environment of the vehicle. In particular, it must be possible to distinguish between passable (driveable) or open areas and impassable areas in the vehicle surroundings.

At the present time, open areas are predominantly determined through the use of video sensors, stereo video sensors and lidar sensors. In particular, the sensor data generated by these sensors can be utilized to create an occupancy grid. For this purpose, the driving environment of the vehicle can be represented as a typically two-dimensional grid structure, each cell of the grid structure being assigned an occupancy value. The occupancy value can be a binary value which has the values “free” and “occupied.” Ternary values can likewise be used, it being additionally possible for a cell to be assigned the value “unknown.”

German Patent No. DE 10 2009 007 395 B4 describes assigning ternary values in this manner on the basis of sensor data.

Modern vehicles typically have a multitude of radar sensors which are also used for detecting obstacles. However, creating an occupancy grid through the direct use of radar sensors is made more difficult because radar reflections are often generated indirectly, for instance, by guardrail or ground reflections. While a free space along a line-of-sight ray up to the first reflection can be assumed when video or lidar sensors are used, this is usually not the case for radar sensors.

### SUMMARY

The present invention provides an example method for creating an inverse sensor model for a radar sensor system. The present invention also relates to a method for detecting obstacles in a driving environment of a vehicle using a radar sensor system. Finally, the present invention provides an example system for creating an inverse sensor model for a radar sensor system.

Preferred embodiments of the present invention are described here in.

Accordingly, in a first aspect of the present invention, the present invention provides a method for creating an inverse sensor model for a radar sensor system. Obstacles having predefined dimensions and spatial positions are placed in a surrounding field of the radar sensor system. Radar measurement data are generated by the radar sensor system. An inverse sensor model is created using the generated radar measurement data and the predefined dimensions and spatial positions of the obstacles. Here, the inverse sensor model assigns an occupancy probability to a cell of an occupancy grid as a function of predefined radar measurement data.

Accordingly, in a second aspect of the present invention, the present invention relates to a method for detecting obstacles in a driving environment of a vehicle using a radar sensor system, an inverse sensor model of the radar sensor system being created. In addition, the radar sensor system is used to generate radar measurement data relevant to the driving environment of the vehicle. Moreover, an occupancy grid is generated; occupancy values for cells of the occupancy grid being ascertained on the basis of the inverse sensor model and using the radar measurement data. Obstacles are detected using the occupancy grid.

A third aspect of the present invention provides a system for creating an inverse sensor model for a radar sensor system. The system has an interface which receives radar measurement data generated by the radar sensor system. In addition, the interface receives information relevant to predefined dimensions and spatial positions of the obstacles in a surrounding field of the radar sensor system. Moreover, the system includes a computing device, which generates an inverse sensor model for the radar sensor system using the received radar measurement data and the information relevant to the predefined dimensions and spatial positions of the obstacles. The inverse sensor model assigns an occupancy probability to a cell of an occupancy grid as a function of predefined radar measurement data.

The example inverse sensor model is generated on the basis of well-defined training data, i.e., on the basis of radar measurement data acquired in a test scenario under known and controllable conditions. During the training phase, the exact position of the obstacles in relation to the radar sensor system and the exact dimensions of the obstacles are known. Thus, the generated radar measurement data may be uniquely assigned to the known driving environment of the vehicle. On the basis of these known values, the inverse sensor model is trained to allow arbitrarily predefined radar measurement data to be analyzed on the basis of the inverse sensor model.

Thus, the present invention makes it possible to generate an inverse sensor model for radar sensor systems. Even the indirect reflections, which are usually difficult to include in the calculations, are considered in the generation of the inverse sensor model, as they are already encompassed in the radar data acquired in the training scenario. As a result, the present invention allows radar sensor systems to be integrated when occupancy grids are generated.

A preferred embodiment of the example method in accordance with the present invention provides that, upon generation of the radar measurement data, the position of the obstacles relative to the radar sensor system be modified, and the radar measurement data be generated for the respective relative positions. This makes it possible to take different scenarios into account to train the inverse sensor model. A specific embodiment provides that the radar sensor system be moved through a test track having set-up obstacles, radar measurement data being generated substantially continuously or at specific time intervals. However, it is also possible to modify the obstacles relative to the radar sensor system, either in terms of the orientation or distance thereof or the position thereof in relation to the radar sensor system. The positions and orientations of the obstacles may be modified relative to each other. The greater the number of different scenarios that are considered, which differ in angular position, the distances of the obstacles, and the shape, respectively materials thereof, the more accurate the inverse sensor model generally becomes. In particular, the accuracy of the occupancy probability for unknown scenarios becomes all the higher, the more training data are used to generate the inverse sensor model.

In accordance with a preferred embodiment of the example method according to the present invention, an occupancy value probability is assigned to the cells and linked to the generated radar measurement data on the basis of the predefined dimensions and spatial positions of the obstacles. The predefined dimensions and spatial positions may be used to compute the exact assignment in the surrounding field of the radar sensor system. Alternatively or additionally, the dimensions and spatial positions may be determined and thereby predefined by further sensor systems, for example, by cameras or lidar systems. In any case, the dimensions and spatial positions of the obstacles are known independently of the radar measurements, i.e., the dimensions and positions are determined without using the radar measurement data. Since the dimensions and spatial positions are known, the occupancy probabilities may be exactly specified for the test scenarios, i.e., for each cell, the occupancy probabilities are 0 or 1, for example.

While the occupancy probabilities are, therefore, exactly known for test scenarios, the occupancy probabilities for unknown scenarios, i.e., unknown radar measurement data are computed by the inverse sensor model. For this, a specific embodiment provides that the inverse sensor model be created by machine learning. It is especially preferred that a neural network be used to create the inverse sensor model, the radar measurement data and the occupancy probabilities linked to the generated radar measurement data, i.e., the values ascertained for the test scenarios, being used as input data for the neural network. It is especially preferred that a convolutional neural network (CNN or ConvNet) be used to generate the inverse sensor model. In particular, the radar measurement data may be presented in the form of grids, a first grid being created on the basis of the reflection values, a second grid on the basis of the corresponding radial velocities, and a third grid on the basis of the ascertained radar cross sections. The first through third grids are used as input data for the CNN. Other grids may be predefined on the basis of further characteristics of the radar measurements. The grids are used to determine the inverse sensor model via the neural network, i.e., to assign occupancy probabilities to predefined radar measurement data.

In accordance with a preferred embodiment of the example method according to the present invention, further sensor systems determine occupancy probabilities which are used as additional input data of the neural network. The sensor systems may preferably include lidar sensors or vehicle cameras. Known methods for determining occupancy probabilities may be used for these further sensor systems. In particular, the circumstance may be considered that, generally, indirect reflections do not occur for lidar sensors or vehicle cameras. In addition, the occupancy probabilities may be determined on the basis of the sensor data from the additional sensor systems using image processing and object detection. Thus, for example, a road surface may be recognized on the basis of video data and classified as passable. The occupancy probabilities may also be ascertained indirectly by inferring from the fact that no reflections are detected within an optical range of a sensor that, with a certain probability, no object is present either. When a lidar system is used, the occupancy probabilities may be generated in angles. The occupancy probabilities may be used to create an occupancy grid, while taking the previous measurement history into account. When a plurality of sensor systems are used, it is possible to merge the sensor data from before the computation of the occupancy probabilities and from after the computation of the respective occupancy probabilities.

Besides the test scenarios, a preferred embodiment of the present invention also takes into account measured values from actual trips. The corresponding dimensions and spatial positions of the obstacles may be provided on the basis of additional sensor data.

Upon generation of the inverse sensor model, a preferred embodiment of the method according to the present invention takes into account an operating range of the radar sensor system, which is ascertained on the basis of the generated radar measurement data and the predefined dimensions and spatial positions of the obstacles. If, in a test scenario, an obstacle of a certain size is located at a certain distance, however, no corresponding radar reflections are determined, it may be inferred that the obstacle resides outside of the operating range of the radar sensor system. Generally, the operating range of the radar sensor system is not a set value, rather is a continuous transition range, within which the detection accuracy of the radar sensor system decreases and essentially approaches zero. For example, the operating range may be taken into account by assigning an occupancy probability of ½ to cells of the occupancy grid, which correspond to regions that are outside of the operating range of the radar sensor system.

In accordance with a preferred embodiment of the method according to the present invention, the radar measurement data analyzed in generating the inverse sensor model include radar cross sections and angle probabilities.

### BRIEF DESCRIPTION OF THE DRAWINGS

FIG. 1 is a schematic block diagram of a system for creating an inverse sensor model.

FIG. 2 is a schematic plan view of a test scenario.

FIG. 3 is an exemplary distance dependency of an occupancy probability for a test scenario.

FIG. 4 is an exemplary distance dependency of an occupancy probability for an arbitrarily predefined driving environment scenario.

FIG. 5 is an exemplary distance dependency of occupancy probabilities in the case of an absence of radar reflections.

FIG. 6 shows an exemplary occupancy grid.

FIG. 7 is a flow chart of a method for creating an inverse sensor model, respectively for detecting obstacles.

In all of the figures, like or functionally equivalent elements and systems are provided with the same reference numerals.

### DETAILED DESCRIPTION OF EXAMPLE EMBODIMENTS

FIG. 1 illustrates a schematic block diagram of a system 1 for creating an inverse sensor model for a radar sensor system 21. Radar sensor system 21 may have a multitude of individual transceiver systems which are designed for emitting radar waves and for receiving the reflected radar waves.

Radar sensor system 21 is preferably integrated in a vehicle 2. Radar sensor system 21 performs radar measurements and generates corresponding radar measurement data, which are transmitted via a signal connection to an interface 11 of system 1. In addition, interface 11 of system 1 is coupled to an external computing system 3, which transmits the exact spatial positions and dimensions of obstacles in a surrounding field of radar sensor system 21 to interface 11. The spatial positions may include two- or three-dimensional spatial coordinates which may, in particular, be specified relative to the position of radar sensor system 21. The dimensions may include the precise spatial dimensions, as well as the exact shape of the obstacles. In addition, information relating to a material characteristic of the obstacles may be transmitted from computing device 3 to interface 11.

The obstacles may be any objects that reflect radar waves, for example, vehicles, people, guardrails, parts of buildings, trees or bushes. The information pertaining to the obstacles, i.e. in particular, the spatial positions, dimensions and possibly material properties, may be entered by a user via a user interface and stored on a memory of computing device 3. Additionally or alternatively, computing device 3 may be linked to other sensors, which ascertain information about the obstacles. For example, the additional sensors may include cameras or lidar sensors.

The information received via interface 11 regarding the obstacles, as well as the received radar measurement data are transmitted to a computing device 12, which is designed for further processing these data.

Computing device 12, as well as computing system 3 may include one or a plurality of microprocessors for processing the data and for implementing the computing operations.

On the basis of the received radar measurement data and the information on the predefined dimensions and spatial positions of the obstacles, computing device 12 computes an inverse sensor model for radar sensor system 21.

An inverse sensor model is understood to be a component, which may be used to produce an occupancy grid. An occupancy probability is assigned to each cell of the occupancy grid as a function of predefined current radar measurement data. The occupancy probability corresponds to the probability at which the respective cell is occupied in the presence of the current radar measurement data. An occupancy value of the cell may be determined on the basis of the occupancy probability. The occupancy value may preferably assume a binary value having the values “occupied” or 1 and “free” or 0. The occupancy value may also be a ternary value, which, additionally, may assume a value “unknown,” and, for example, be represented by value ½. In accordance with other specific embodiments, the occupancy value may assume continuous values of between 0 and 1.

The occupancy grid itself may preferably be a symmetrical grid, each cell being assigned the computed occupancy value. Typically, the occupancy grid models the driving environment of the vehicle, thus, is fixed relative to the fixed elements therein. This means that the vehicle itself, as well as other dynamic objects move through the occupancy grid. During the movement of vehicle 2, new sensor data are generated which are used to update the occupancy grid, i.e., to dynamically adapt the occupancy values of the cells of the occupancy grid. In particular, on the basis of the current radar measurement data, the generated inverse sensor model may be used to determine the corresponding occupancy probabilities of cells. The occupancy probabilities may be used for dynamically adapting the occupancy values of the cells. In particular, the a posteriori probability may be computed for each cell using a recursive updating equation, referred to as a binary Bayes filter, i.e., taking into account the entire measurement history. In accordance with a specific embodiment, in this regard, the individual cells may be assumed to be conditionally independent of each other.

The occupancy grid makes it possible to describe the driving environment two-dimensionally, both the obstacles in the driving environment of the vehicle, as well as passable areas being recognized. Thus, the occupancy grid renders possible a free space modeling, respectively unoccupied area modeling.

The generated inverse sensor model may be transmitted to a driving assistance system 22 which, on the basis of the inverse sensor model, uses acquired radar measurement data to detect obstacles and control vehicle 2 semi-autonomously or autonomously.

The following more accurately illustrates computing device 12 generating the inverse sensor model.

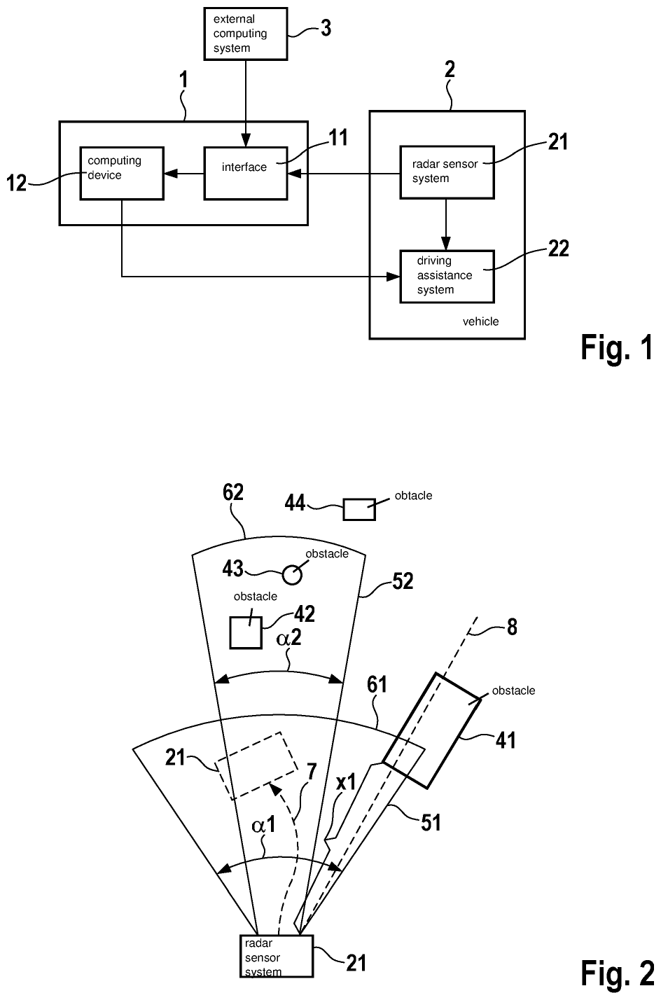

FIG. 2 illustrates an exemplary test scenario, i.e., a positioning of radar sensor system 21 in a driving environment having predefined obstacles 41 through 44. Radar sensor system 21 preferably moves along a defined path 7; at every point in time, the exact position of obstacles 41 through 44 in relation to radar sensor system 21 being ascertained by computing system 3 and transmitted to system 1. Radar sensor system 21 determines radar measurement data in a near field 51 and radar measurement data in a far field 52; the captured areas being characterized by respective detection angles a1, a2 and operating ranges 61, 62. The relevant information on obstacles 41 through 44 is assigned to the respective radar measurement data. The radar measurement data include the totality of all radar reflections (locations), as well as the properties thereof, in particular the corresponding angle probabilities and radar cross sections.

Using the dimensions and spatial positions of the obstacles, computing device 12 is able to assign the corresponding occupancy probabilities of the cells of the occupancy grid to the respective radar measurement data.

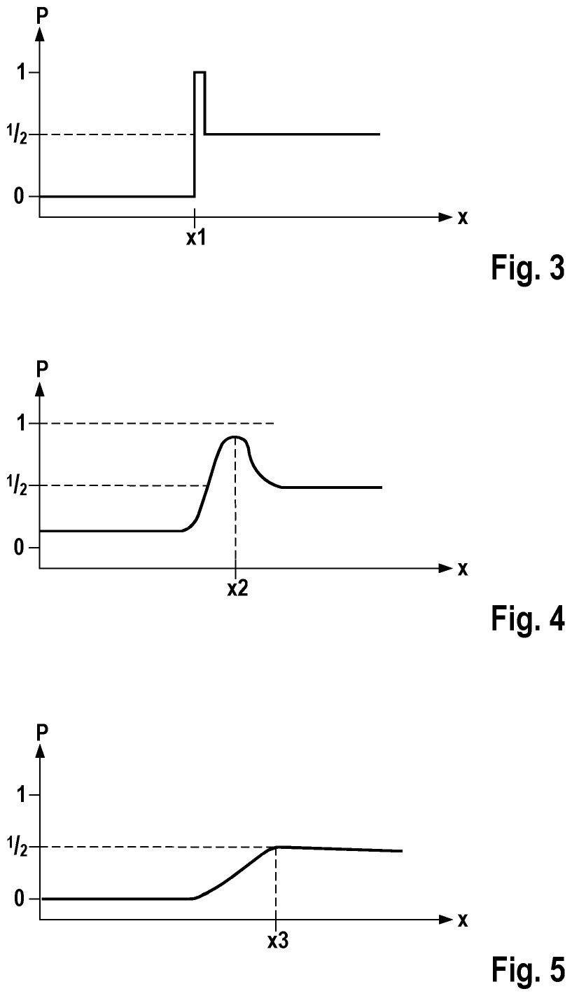

FIG. 3 shows this exemplarily for the cells of an occupancy grid along a line of sight 8. For distances x smaller than a distance x1 to a first obstacle 41, the occupancy probability is equal to 0. The occupancy probability is 1 for the cell which is situated along line of sight 8 at a distance x1 from radar sensor system 21, since an obstacle 41 is located at this location with certainty. Since obstacle 41 hides the areas that are further away, it is not possible to provide any details thereabout. Accordingly, the occupancy probability may be assigned a value of ½.

Analogously to this example, computing device 12 computes the occupancy probabilities for each piece of the received radar measurement data for all cells of the occupancy grid using the information on obstacles 41 through 44. These ascertained occupancy probabilities form input data for a neural network that computing device 12 uses to compute the inverse sensor model. Other input data for the neural network may include additional sensor data from vehicle cameras or lidar sensors. The inverse sensor model is able to analyze any radar measurement data and assign a particular corresponding occupancy probability to the cells of the occupancy grid.

FIG. 4 illustrates this for an exemplary scenario along a specific line of sight. The occupancy probability not only assumes the values 0, ½ and 1 for general scenarios, but generally assumes any values between 0 and 1. Thus, even in the absence of reflections, the probability is generally not equal to 0 due to possible measurement inaccuracies or noise, and exact position x2 is generally not known even when a reflection is received. Rather the occupancy probability will generally continuously increase to a value close to 1. For larger distances, the value generally drops to ½, since, again, it is not possible to provide any details about the occupancy.

FIG. 5 illustrates another exemplary distance dependency of an occupancy probability determined by the inverse sensor model. In this case, basically no radar reflections or only a few thereof are received along the examined line of sight. Therefore, the occupancy probabilities for relatively small distances are essentially zero. However, the occupancy probability will increase for relatively large distances and, beyond an operating range x3 of radar sensor system 21, again, assume value ½ since it is not possible to provide any details for this distance range.

Operating range x3 of radar sensor system 21 may be taken into account upon generation of the inverse sensor model. Thus, for example, obstacle 44 illustrated in FIG. 2 is not detected, as it is outside the operating range of radar sensor system 21.

Only upon approach of radar sensor system 21 along path 7, does obstacle 44 move into the sensing range of radar sensor system 21. When the inverse sensor model is generated by machine learning, for instance, using deep neural networks, scenarios of this kind are likewise trained at the same time.

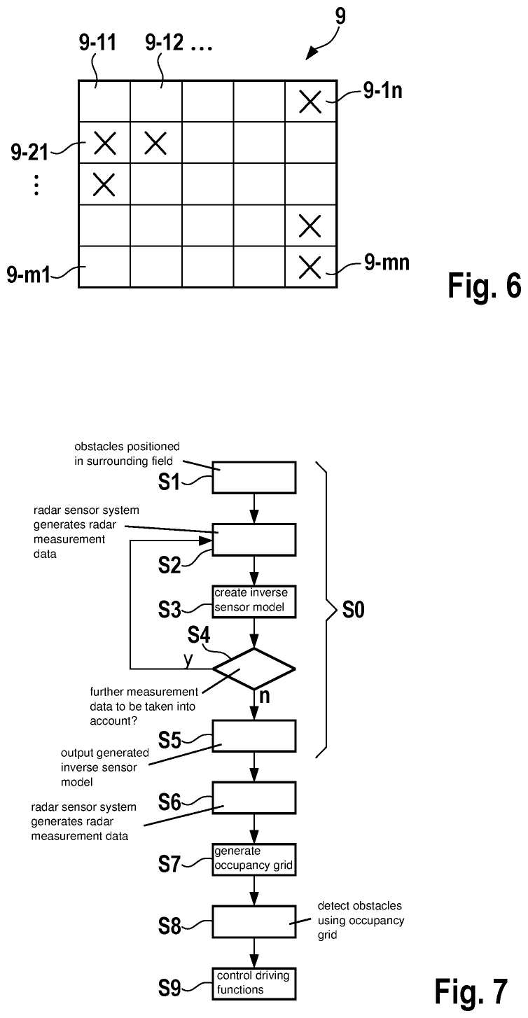

FIG. 6 illustrates an exemplary occupancy grid 9, which may be produced by the generated inverse sensor model. Occupancy grid 9 is dynamically updated by the inverse sensor model analyzing newly generated radar measurement data to determine occupancy probabilities and by the occupancy values being updated on the basis of the ascertained occupancy probabilities. Bayer filters may be used to ascertain a new occupancy value, for example. An occupancy value of 0 (free) or 1 (occupied, marked by crosses) is assigned to individual cells 9-11 through 9 mn of occupancy grid 9, m and n being natural numbers. The occupancy value of a cell 9-ij will change, in particular when new measurements yield high occupancy probabilities of cell 9-ij in question.

The occupancy probabilities may be merged with other occupancy probabilities acquired on the basis of other sensor data. The further sensor data may be generated via vehicle cameras or lidar sensors, for example, making it possible to more accurately determine the occupancy probabilities.

FIG. 7 illustrates a flow chart of a method for creating an inverse sensor model for a radar sensor system 21, as well as a method for detecting obstacles. Method S0 for creating an inverse sensor model includes method steps S1 through S5, the method for detecting obstacles having additional method steps S6 through S9.

In a first method step S1, obstacles 41 through 44 are positioned in a surrounding field of radar sensor system 21. Information is obtained on the dimensions, spatial positions and, when indicated, the materials used, respectively the reflective properties of obstacles 41 through 44. This information may be generated by additional sensor systems. Alternatively, obstacles 41 through 44 may positioned in such a way that the spatial positions thereof are known. The relevant information may be transmitted manually by a user to a system 1 for generating the driving environment model.

In a method step S2, radar sensor system 21 generates radar measurement data. For this purpose, radar sensor system 21 is preferably moved relative to obstacles 41 through 44; at every detection instant, the corresponding relative orientation among obstacles 41 through 44 and radar sensor system 21 being known. Alternatively or additionally, obstacles 41 through 44 may also be moved relative to radar sensor system 21.

In a method step S3, an inverse sensor model is created using the generated radar measurement data and the predefined information, i.e., in particular the dimensions and spatial positions of obstacles 41 through 44. The inverse sensor model may be created, in particular by an above described computing device 12 in accordance with one of the above described methods.

Thus, on the basis of information about obstacles 41 through 44, in particular cells 9-ij of occupancy grid 9 may be assigned occupancy probabilities, and these may be linked to the corresponding radar measurement data. These linked data are used as input data of the neural network. In addition, other sensor data may be used as input data of the neural network. The neural network creates the inverse sensor model which assigns an appropriate occupancy probability to cells 9-ij of occupancy grid 9 as a function of arbitrarily predefined radar measurement data.

A method step S4 checks whether further radar measurement data should be taken into account for generating and adapting the inverse sensor model. If indicated, new radar measurement data are generated, S2, and the inverse sensor model is adapted accordingly, S3. In particular, using the new data, the parameters of the inverse sensor model may be adapted by the neural network.

In the case that no further radar measurement data are to be considered, the generated inverse sensor model is output in a method step S5.

In other optional steps S6 through S9, the generated inverse sensor model may be used for detecting obstacles 41 through 44 in a driving environment of vehicle 2.

In this regard, radar measurement data are generated in a method step S6 by a radar sensor system 21, which is identical or identical in design to radar sensor system 21 used in steps S1 through S5.

In a method step S7, an occupancy grid is generated, respectively updated; occupancy probabilities for cells 9-ij of occupancy grid 9 being ascertained on the basis of the inverse sensor model using the radar measurement data as input data. The occupancy probabilities may additionally be used for generating the occupancy values of cells 9-ij of occupancy grid 9, in the case that they are already present.

In a method step S8, obstacles 41 through 44 are detected using occupancy grid 9. Obstacles 41 through 44 correspond to those areas, which are occupied, i.e. corresponding cells 9-ij of occupancy grid 9 have an occupancy value of 1.

Additionally, in an optional method step S9, driving functions of vehicle 2 may be controlled on the basis of detected obstacles 41 through 44. In particular, vehicle 2 may be accelerated or decelerated, or the driving direction of the vehicle may be adapted.

1-10. (canceled)

11. A method for creating an inverse sensor model for a radar sensor system, comprising the following steps:
placing obstacles having predefined dimensions and spatial positions in a surrounding field of the radar sensor system;
generating, by the radar sensor system, radar measurement data; and
generating the inverse sensor model using the generated radar measurement data and the predefined dimensions and spatial positions of the obstacles, the inverse sensor model assigning an occupancy probability to a cell of an occupancy grid as a function of predefined radar measurement data.

12. The method as recited in claim 11, wherein, upon the generation of the radar measurement data, positions of the obstacles relative to the radar sensor system are modified, and radar measurement data are generated for the modified relative positions.

13. The method as recited in claim 11, wherein occupancy probabilities are assigned to cells of the occupancy grid based on the predefined dimensions and spatial positions of the obstacles, and are linked to the generated radar measurement data.

14. The method as recited in claim 13, wherein the inverse sensor model is created using a neural network, the radar measurement data and the occupancy probabilities linked to the generated radar measurement data being used as input data for the neural network.

15. The method as recited in claim 14, wherein further sensor systems determine occupancy probabilities of the cells of the occupancy grid, which are used as additional input data of the neural network.

16. The method as recited in claim 15, wherein the further sensor systems including lidar sensors or vehicle cameras.

17. The method as recited in claim 11, wherein upon generation of the inverse sensor model, an operating range of the radar sensor system is considered, which is ascertained based on the generated radar measurement data and the predefined dimensions and spatial positions of the obstacles.

18. The method as recited in claim 11, wherein the radar measurement data used to generate the inverse sensor model including radar cross sections and angle probabilities.

19. A method for detecting obstacles in a driving environment of a vehicle using a radar sensor system, comprising the following steps:
creating an inverse sensor model of the radar sensor system, the creating including placing obstacles having predefined dimensions and spatial positions in a surrounding field of the radar sensor system, generating, by the radar sensor system, radar measurement data, and generating the inverse sensor model using the generated radar measurement data and the predefined dimensions and spatial positions of the obstacles, the inverse sensor model configured to assign an occupancy probability to a cell of an occupancy grid as a function of predefined radar measurement data;
generating additional radar measurement data with respect to the driving environment of the vehicle using the radar sensor system,
generating the occupancy grid, occupancy values for the cells of the occupancy grid being ascertained based on the inverse sensor model using the additional radar measurement data, and
detecting obstacles using the occupancy grid.

20. A system for creating an inverse sensor model for a radar sensor system, comprising:
an interface that is configured to receive radar measurement data generated by radar sensor system and information related to predefined dimensions and spatial positions of the obstacles in a surrounding field of the radar sensor system; and
a computing device configured to generate an inverse sensor modal for the radar sensor system using the received radar measurement data and the information on the predefined dimensions and spatial positions of the obstacles, the inverse sensor model assigning an occupancy probability to a cell of an occupancy grid as a function of predefined radar measurement data.
